(19) United States
(12) Patent Application Publication
(10) Pub. No.: US 2012/0000930 A1
(43) Pub. Date: Jan. 5, 2012

(54) ACU-SPRAY AEROSOL STRAW SYSTEMS

(76) Inventor: Richard G. Barbieri, Morris, NY (US)

(21) Appl. No.: 13/069,383

(22) Filed: Mar. 23, 2011

Related U.S. Application Data
(60) Provisional application No. 61/359,921, filed on Jun. 30, 2010.

(51) Int. Cl. B67D 7/00; B67D 7/06

(52) U.S. Cl. 222/1; 222/527

(57) ABSTRACT

Acu-Spray Aerosol Straw is designed to allow the contents of a pressurized container to be dispensed at virtually any angle. Acu-Spray Aerosol Straw comprises a bendable, plastic straw. A wire is molded into the sidewall of the straw or molded integral to the straw tube as supporting means. The wire may be housed in a plastic casing and then molded onto the side of the original aerosol straw. The molding together of the wire that is encased and the straw-tube effectively prevents the separation of the two components due to bending. The bendable straw in combination with the wire is bendably-manipulatable such that a propelled fluid from a pressurized container is strategically dispensed onto a user-defined location. The device may be detachable from the nozzle to prevent breakage while the can is in storage. In certain embodiments the device may comprise a non-wire version wherein the bendable straw may be a non-bendable rigid structure. The rigid straw embodiment may comprise L-shaped, C-shaped, V-shaped configurations and/or other such shapes.

### CROSS-REFERENCE TO RELATED APPLICATION

The present application is related to and claims priority from prior provisional application Ser. No. 61/359,921, filed Jun. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of aerosol spray cans and more specifically relates to aerosol spray can attachments.

### 2. Description of the Related Art

Aerosol spray cans may be used as a dispensing means which creates an aerosol mist of liquid particles. The can or bottle contains the liquid(s) under pressure. When the container's valve is opened, the liquid may be forced out of a small aperture and emerges as an aerosol or mist. As gas expands to drive out the fluid, only some propellant evaporates inside the can to maintain an even pressure. Outside the aerosol can, the droplets of propellant tend to evaporate rapidly, leaving the fluid suspended as very fine mist-droplets.

Aerosol cans may be used as applicators for a multitude of products and allow liquids to be sprayed substantially evenly while the cans are held in upright positions. However, when a can is tilted, the gas propellant may be used up at a disproportionately fast rate to the fluid itself. This prevents consumers from being able to access the remaining contents of the aerosol cans. Additionally, consumers may need to apply an aerosol product to immovable items located in hard-to-reach areas, but may be unable to direct the can at the proper angles to efficiently and effectively dispense the product.

Various attempts have been made to solve the above-mentioned problems such as those found in U.S. Pat. Nos. 5,529,226; 6,824,025; 5,890,631; 7,077,295; 4,305,528; and 3,402,741. This prior art is representative of spray nozzle attachments. None of the above inventions and patents, taken either singly or in combination, are seen to describe the invention as claimed.

Ideally, an aerosol spray system should be user-friendly, operate reliably and be manufactured at a modest expense. Thus, a need exists for a reliable aerosol straw system to efficiently and effectively dispense propelled fluid(s) and to avoid the above-mentioned problems.

### BRIEF SUMMARY OF THE INVENTION

In view of the foregoing disadvantages inherent in the known fluid dispensing art, the present invention provides a novel aerosol dispensing system, the Acu-Spray Aerosol Straw System. The general purpose of the present invention, which will be described subsequently in greater detail is to provide efficient and effective dispensing means for propelled fluid(s).

A bendable fluid communicating system is disclosed herein preferably comprising: a bendable straw having a continuous through-hole defined by a straw-tube with an inner and outer circumferential surface, the bendable straw having a proximate and a distal end; and a wire of semi-rigid (bendable/pliable) material. In a first embodiment, the wire may be attached to the outside of the straw-tube such that the wire runs along the outer circumferential surface or alternately in a second embodiment the wire is formed/molded into the sidewall of the straw-tube integral to/with the straw-tube, such that they work in combination to provide supported-bending means. In the primary embodiment the wire may be contained in a plastic casing and then molded onto/attached to the outside of the straw-tube. This particular wire of the first embodiment is preferably comparably equivalent in diameter to the inner diameter of the plastic casing, such that the wire is flush with the plastic casing. However, it may also be smaller in diameter than the inner diameter of the plastic casing such that the wire may move slightly in relation to the plastic casing (creating a float-relationship within the casing). The wire in both embodiments substantially prevents kinking of the bendable straw along its entire length. The bendable straw preferably comprises plastically-deformable material (plastic or other suitable equivalent material.) In these ways the bendable straw is repeatedly bendable such that fatigue stresses are minimized. In further embodiments the bendable straw may comprise L-shaped configurations, C-shaped, V-shaped or other such shapes. In this and other embodiments the bendable straw may not be bendable. In such an embodiment, the wire may not be necessary/used.

The bendable straw also is preferably removably attachable to a nozzle on a pressurized container such that it may be removed for storage, between uses or for use with another full aerosol can when the original aerosol can's contents have been depleted. However, the bendable straw may be permanently attached to an aerosol/pressurized nozzle apparatus or an aerosol/pressurized can. The bendable straw preferably comprises a length of at least about three inches in certain embodiments and other lengths in other embodiments for use in various applications.

The bendable straw is preferably variably-contortable at various nondescript nodes to match at least one contoured profile that is user-defined by bending it into the user-desired shape. The bendable straw is suitably supported in these conditions by the wire to maintain a continuous through-hole uniformly throughout the length of the bendable straw to provide that a steady flow-volume of the propelled fluid is able to be consistently dispensed from the bendable straw onto the workpiece.

The bendable straw, when variably-contorted, provides that the pressurized container is able to remain in a favorable substantially vertically-oriented position (upright) such that the pressurized container is able to be substantially emptied so that the propelled fluid is depleted in its entirety making the invention cost-effective for users of aerosols (in-use). The bendable straw when in combination with the wire is bendably-manipulatable such that the propelled fluid from the pressurized container may be strategically dispensed onto a user-defined location. In certain embodiments the device may comprise a non-wire version wherein the bendable straw may be a non-bendable rigid structure.

A method for using a bendable fluid communicating system is also described herein comprising the steps of: removably coupling a bendable straw with a wire support to a pressurized container; contorting the bendable straw at various nondescript nodes along its length into a user-preferred profile; and dispensing a propelled fluid into a user-defined location.

The present invention, the Acu-Spray Aerosol Straw System holds significant improvements to existing aerosol dispensing methods. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, the acu-spray aerosol straw system, constructed and operative according to the teachings of the present invention.

FIG. 1 shows a perspective view illustrating an acu-spray aerosol straw system in an in-use condition according to an embodiment of the present invention.

FIG. 2 is another perspective view the acu-spray aerosol straw system in another in-use condition according to an embodiment of the present invention of FIG. 1.

FIG. 3 is yet another perspective view illustrating the acu-spray aerosol straw system in a further in-use condition according to an embodiment of the present invention of FIG. 1.

FIG. 4 is yet another perspective view illustrating the acu-spray aerosol straw system in a further in-use condition according to an embodiment of the present invention of FIG. 1.

FIG. 5 is a flowchart illustrating a method of use for the acu-spray aerosol straw system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a dispensing means and device and more particularly to acu-spray aerosol straw system 100 as used to improve the efficiency, effectiveness by which propelled fluid(s) may be dispensed into user-preferred locations.

Generally speaking, acu-spray aerosol straw system 100 of the present invention permits pressurized container 150 to be held upright while dispensing an even stream of a user designated product from several different angles; the preferred positioning being a substantially vertically-oriented position when spray-delivering propelled fluid(s).

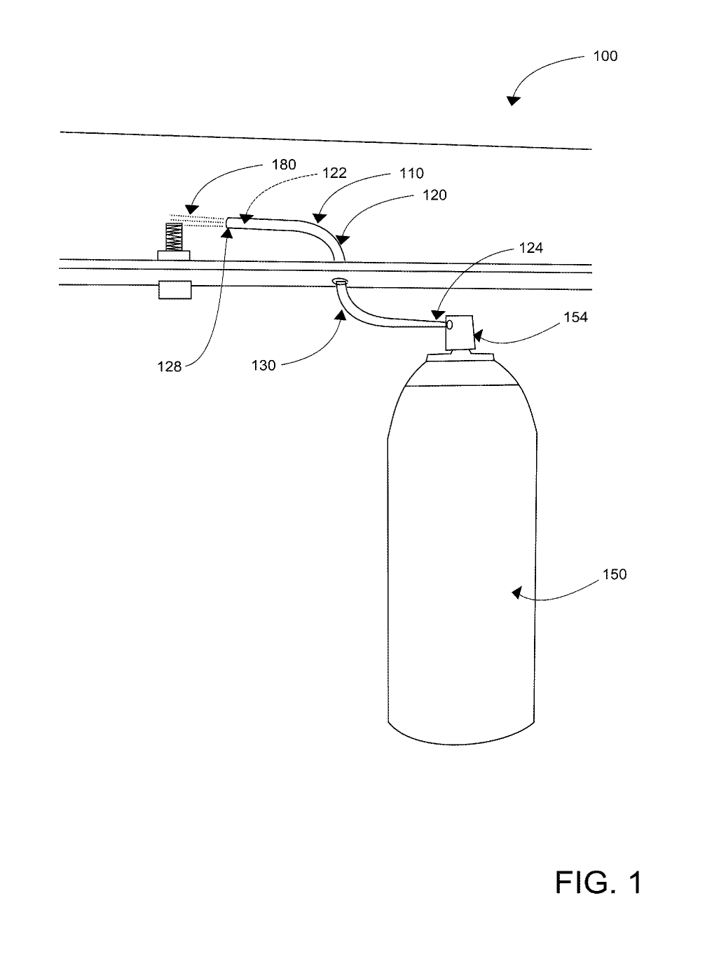

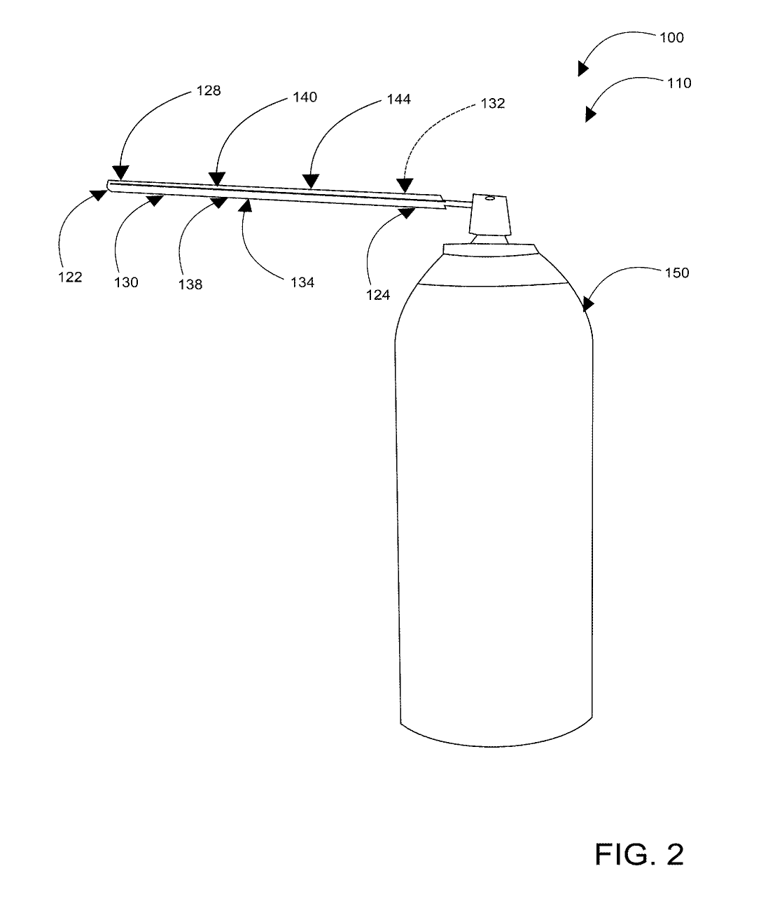

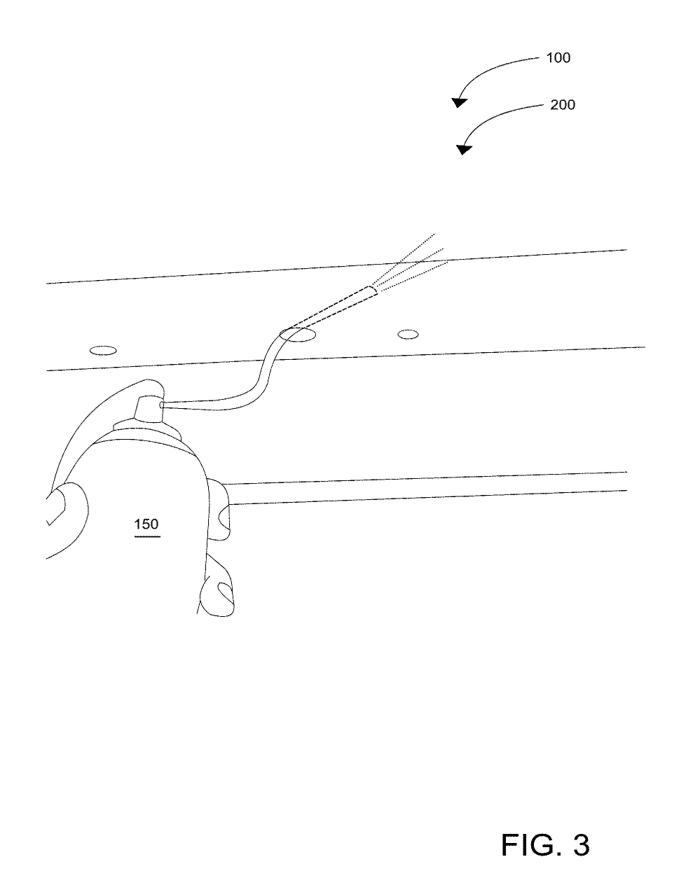

Referring now more specifically to the drawings by numerals of reference there is shown in FIG. 1-4, perspective views illustrating acu-spray aerosol straw system 100 in various ‘in-use’ conditions, according to embodiments of the present invention. Aerosol straw system 100 preferably comprises bendable fluid communicator 110. Bendable fluid communicator 110 may easily be applied to (inserted into frictional contact with) nozzle 154 of pressurized container 150. Bendable communicator 110 preferably is repeatedly removably attachable to nozzle 154 to substantially prevent breakage while pressurized container 150 is not in use and to minimize storage space required. Pressurized container 150 preferably comprises an aerosol can, however other pressurized containers 150 may be used. Pressurized container 150 is able to remain in a substantially vertically-oriented position such that pressurized container 150 is able to be emptied so that a propelled fluid is depleted in entirety.

Bendable fluid communicator 110 includes bendable straw 120 and wire 140. Bendable straw 120 preferably comprises plastically-deformable material and comprises a length of at least three inches. Upon reading this specification, it should be appreciated that, under appropriate circumstances, considering such issues as user preferences, design preference, structural requirements, marketing preferences, cost, available materials, technological advances, etc., other comparable materials and dimensions/lengths may be sufficient. Also in further embodiments bendable straw 120 may comprise L-shaped configurations, C-shaped, V-shaped or other such shapes. In this and other embodiments bendable straw 120 may not be bendable. In such an embodiment, wire 140 may not be necessary/used.

Bendable straw 120 preferably includes continuous through-hole 122 defined by straw-tube 130 with inner circumferential surface 132 and outer circumferential surface 134. Continuous through-hole 122 is uniformly retained by wire 140 to effectively ensure a steady flow-volume of a propelled fluid is dispensed from bendable straw 120 during aerosol/fluid application. Further, bendable straw 120 includes proximate end 124 and distal end 128. Proximate end 124 of bendable straw 120 is removably-attachable to nozzle 154 while distal end 128 comprises an end of continuous through-hole 122 where propelled fluid 180 from pressurized container 150 may be dispensed.

Wire 140 is preferably attached to side 138 of straw-tube 130 such that wire 140 preferably runs along outer circumferential surface 134 (so as to not affect coupling.) It should be noted that wire 140 may be molded/formed into the sidewall of straw-tube 130 integral to straw-tube 130 as well. Wire 140 preferably comprises ferrous material. Bendable straw 120 in combination with wire 140 is preferably bendably-manipulatable such that a propelled fluid from pressurized container 150 may be strategically dispensed onto a user-defined location as shown in the present figures.

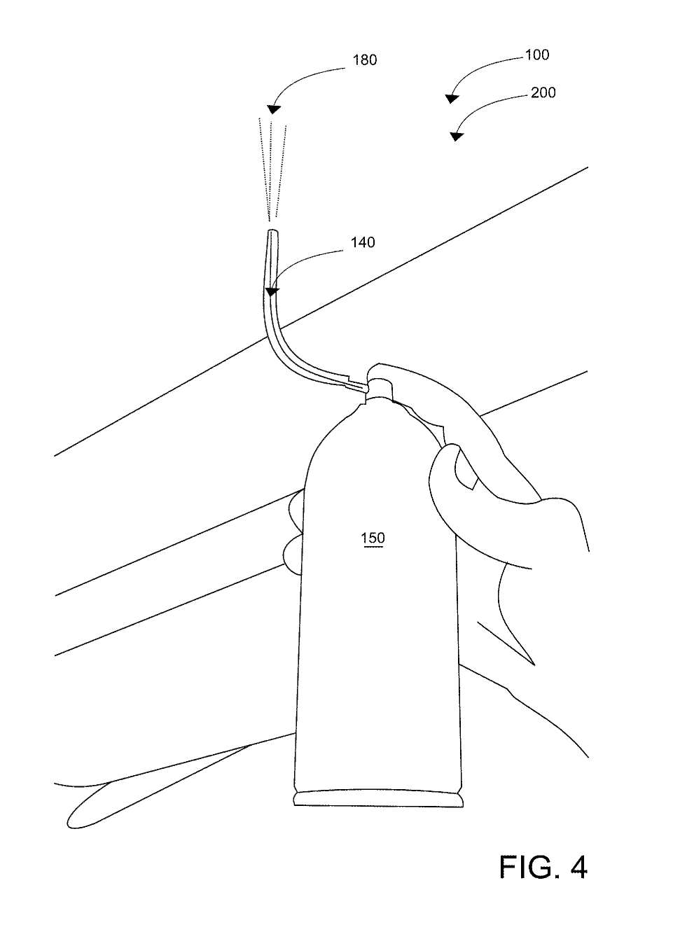

Wire 140 may be contained in plastic casing 144 and then molded onto/attached to side 138 of straw-tube 130. The molding together of wire 140 and straw-tube 130 preferably prevents the separation of wire 140 and straw-tube 130 due to inherent bending stresses. A benefit of using wire 140 in combination with bendable straw 120 is that wire 140 effectively prevents kinking of bendable straw 120 along its length. It should be noted that wire 140 is comparably equivalent in diameter to the inner diameter of plastic casing 144, such that wire 140 is flush with the plastic casing. However, it may also be smaller in diameter than an inner diameter of plastic casing 144 such that wire 140 may move slightly in relation to plastic casing 144. In an alternate embodiment, as shown in FIG. 4, wire 140 may comprise a rigid rod (that is repeatedly bendable.) Bendable straw 120 may comprise a non-wire structural rigid straw structure in certain embodiments such as in instances wherein non-bendable rigid structure comprises an L-shaped, a C-shaped, and/or a V-shaped configuration which may be used for applications for spraying heavy material such as undercoat or the like.

To permit the bending of bendable straw 120, bendable straw 120 is variably-contortable at various nondescript nodes. Bendable straw 120 may be variably-contortable to match at least one user-defined contour. Bendable straw 120 may be suitably supported by wire 140 to maintain continuous through-hole 122 uniformly throughout bendable straw 120. Bendable straw 120 when variably-contorted provides that pressurized container 150 is able to remain in a substantially vertically-oriented position when in an ‘in-use’ condition as illustrated in FIGS. 1-3.

Acu-spray aerosol straw system 100 according to an embodiment of the present invention of FIGS. 1-4 may comprise kit 440. Kit 440 may comprise the following parts: bendable straw 120; wire 140; (to be sold with or without) nozzle 154; pressurized container 150; and a set of user instructions. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, or parts may be sold separately.

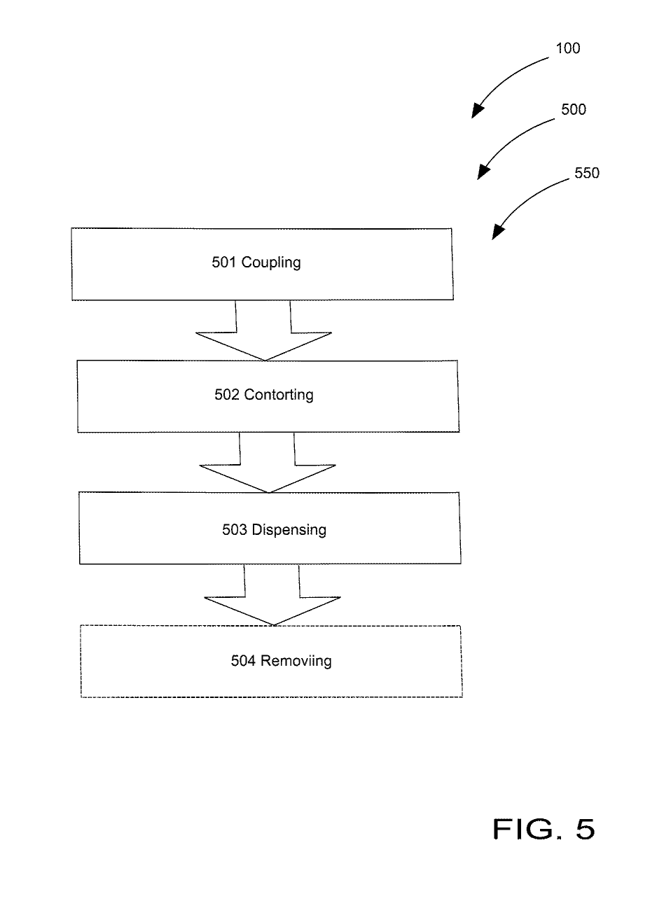

Referring now to FIG. 5, showing a method of use 500 for using bendable fluid communicating system 100 comprising the steps of: step one 501 removably coupling bendable straw 120 with wire support 140 to pressurized container 150; step two 502 contorting bendable straw 120 at nondescript nodes along its length into a user-preferred profile; and step three 503 dispensing a propelled fluid into a user-defined location. Optionally, bendable straw 120 may be removed for an in-storage condition, as a further step four 504.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations, and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bendable fluid communicating system comprising:
a bendable straw having a continuous through-hole defined by a straw-tube with an inner and outer circumferential surface, said bendable straw having a proximate and a distal end;
a wire;
wherein said wire is attached to a side of said straw-tube such that said wire runs along said outer circumferential surface;
wherein said bendable straw in combination with said wire is bendably-manipulatable such that a propelled fluid from a pressurized container may be strategically dispensed onto a user-defined location.

2. The bendable fluid communicating system of claim 1 wherein said wire is contained in a plastic casing and then molded/attached onto said side of said straw-tube.

3. The bendable fluid communicating system of claim 1 wherein said wire is comparably equivalent in diameter to the inner diameter of a plastic casing, such that said wire is flush with said plastic casing or is smaller in diameter than an inner diameter of said plastic casing such that said wire may move slightly in relation to said plastic casing.

4. The bendable fluid communicating system of claim 1 wherein said bendable straw is repeatedly removably attachable to a nozzle on said pressurized container.

5. The bendable fluid communicating system of claim 1 wherein said pressurized container comprises an aerosol can.

6. The bendable fluid communicating system of claim 1 wherein said bendable straw is variably-contortable at various nondescript nodes.

7. The bendable fluid communicating system of claim 6 wherein said bendable straw is variably-contortable to match at least one contour.

8. The bendable fluid communicating system of claim 1 wherein said bendable straw is suitably supported by said wire to maintain said continuous through-hole uniformly throughout said bendable straw and said wire prevents kinking of said bendable straw along its length.

9. The bendable fluid communicating system of claim 1 wherein said bendable straw and said wire are repeatably bendable at different nondescript nodes.

10. The bendable fluid communicating system of claim 6 wherein said bendable straw when variably-contorted provides that said pressurized container is able to remain in a substantially vertically-oriented position when spray-delivering said propelled fluid.

11. The bendable fluid communicating system of claim 10 wherein said pressurized container is able to remain in said substantially vertically-oriented position such that said pressurized container is able to be emptied so that said propelled fluid is depleted in entirety.

12. The bendable fluid communicating system of claim 1 wherein said wire comprises a rigid repeatably bendable rod of ferrous material.

13. The bendable fluid communicating system of claim 12 wherein said bendable straw comprises a non-wire structural rigid straw structure.

14. The bendable fluid communicating system of claim 1 wherein said wire is integral to said straw-tube in a sidewall of said straw-tube.

15. The bendable fluid communicating system of claim 8 wherein said continuous through-hole is uniformly retained by said wire to provide that a steady flow-volume of said propelled fluid is dispensed uniformly from said bendable straw.

16. The bendable fluid communicating system of claim 1 wherein said bendable straw comprises plastically-deformable material.

17. The bendable fluid communicating system of claim 12 wherein said bendable straw comprises a non-bendable rigid structure.

18. The bendable fluid communicating system of claim 17 wherein said non-bendable rigid structure comprises an L-shaped, a C-shaped, and/or a V-shaped configuration.

19. A bendable fluid communicating system comprising:
a bendable straw having a continuous through-hole defined by a straw-tube with an inner and outer circumferential surface, said bendable straw having a proximate and a distal end;
a wire of semi-rigid material;
wherein said wire is attached to a side of said straw-tube such that said wire runs along said outer circumferential surface or said wire is integral to said straw-tube;
wherein said wire is contained in a plastic casing and then molded onto said side of said straw-tube;
wherein said wire is smaller in diameter than an inner diameter of said plastic casing such that said wire may move slightly in relation to said plastic casing;
wherein said wire prevents kinking of said bendable straw along its length;
wherein said bendable straw is repeatedly removably attachable or permanently attached to a nozzle on a pressurized container;
wherein said bendable straw comprises plastically-deformable material;
wherein said pressurized container comprises an aerosol can;
wherein said bendable straw is variably-contortable at various nondescript nodes;
wherein said bendable straw is variably-contortable to match at least one contoured profile;
wherein said bendable straw is suitably supported by said wire to maintain said continuous through-hole uniformly throughout said bendable straw;
wherein said continuous through-hole is uniformly retained by said wire to provide that a steady flow-volume of said propelled fluid is dispensed through said bendable straw;
wherein said bendable straw when variably-contorted provides that said pressurized container is able to remain in a substantially vertically-oriented position;
wherein said pressurized container is able to remain in said substantially vertically-oriented position such that said pressurized container is able to be emptied so that said propelled fluid is depleted in entirety; and
wherein said bendable straw in combination with said wire is bendably-manipulatable such that a propelled fluid from said pressurized container may be strategically displaced onto a user-defined location.

20. A method for using a bendable fluid communicating system comprising the steps of:
removably coupling a bendable straw with a wire support to a pressurized container;
contorting said bendable straw at nondescript nodes along its length into a user-preferred profile; and
dispensing a propelled fluid into a user-defined location.
